(19) United States
(12) Patent Application Publication
(10) Pub. No.: US 2017/0075589 A1
(43) Pub. Date: Mar. 16, 2017

(54) MEMORY AND BUS FREQUENCY SCALING BY DETECTING MEMORY-LATENCY-BOUND WORKLOADS

(71) Applicant: Qualcomm Innovation Center, Inc., San Diego, CA (US)

(72) Inventors: Saravana Krishnan Kannan, San Diego, CA (US); Anil Vootukuru, San Diego, CA (US); Rohit Gaurishankar Gupta, San Diego, CA (US)

(21) Appl. No.: 15/225,622

(22) Filed: Aug. 1, 2016

Related U.S. Application Data
(60) Provisional application No. 62/218,413, filed on Sep. 14, 2015.

(51) Int. Cl. G06F 3/06; G06F 12/0811; G06F 12/1009

(52) U.S. Cl. CPC G06F 3/0611; G06F 12/1009; G06F 3/0625; G06F 3/0647; G06F 3/0673; G06F 12/0811; G06F 2212/1028

(57) ABSTRACT

Disclosed are systems and methods for adjusting a frequency of memory of a computing device. The method may include counting, in connection with a hardware device, a number of instructions executed and a number of requests to the memory during N milliseconds and calculating a workload ratio that is equal to a ratio of the number of instructions executed to the number of requests to memory. If the workload ratio is less than a ratio-threshold, then the memory vote is determined based upon a frequency of the hardware device. A frequency of the memory is managed based upon an aggregation of the memory-frequency vote and other frequency votes.

### CLAIM OF PRIORITY UNDER 35 U.S.C. §119

The present Application for Patent claims priority to Provisional Application No. 62/218,413 entitled “Memory and Bus Frequency Scaling by Detecting Memory Latency Bound Workloads” filed Sep. 14, 2015, and assigned to the assignee hereof and hereby expressly incorporated by reference herein.

### BACKGROUND

I. Field of the Disclosure

The technology of the disclosure relates generally to data transfer between hardware devices and memory constructs, and more particularly to control of the electronic bus and memory frequencies.

II. Background

Electronic devices, such as mobile phones, personal digital assistants (PDAs), and the like, are commonly manufactured using application specific integrated circuit (ASIC) designs. Developments in achieving high levels of silicon integration have allowed creation of complicated ASICs and field programmable gate array (FPGA) designs. These ASICs and FPGAs may be provided in a single chip to provide a system-on-a-chip (SOC). An SOC provides multiple functioning subsystems on a single semiconductor chip, such as for example, processors, multipliers, caches, and other electronic components. SOCs are particularly useful in portable electronic devices because of their integration of multiple subsystems that can provide multiple features and applications in a single chip. Further, SOCs may allow smaller portable electronic devices by use of a single chip that may otherwise have been provided using multiple chips.

To communicatively interface multiple diverse components or subsystems together within a circuit provided on a chip(s), which may be an SOC as an example, an interconnect communications bus, also referred to herein simply as a bus, is provided. The bus is provided using circuitry, including clocked circuitry, which may include as examples registers, queues, and other circuits to manage communications between the various subsystems. The circuitry in the bus is clocked with one or more clock signals generated from a master clock signal that operates at the desired bus clock frequency(ies) to provide the throughput desired. In addition, system memory (e.g., DDR memory) is also clocked with one or more clock signals to provide a desired level of memory frequency.

In applications where reduced power consumption is desirable, the bus clock frequency and memory clock frequency can be lowered, but lowering the bus and memory clock frequencies lowers performance of the bus and memory, respectively. If lowering the clock frequencies of the bus and memory increases latencies beyond latency requirements or conditions for the subsystems coupled to the bus interconnect, the performance of the subsystem may degrade or fail entirely. Rather than risk degradation or failure, the bus clock and memory clock may be set to higher frequencies to reduce latency and provide performance margin, but providing higher bus and memory clock frequencies consumes more power.

Some workloads, referred to herein as memory-latency-bound workloads, are processed with a relatively few number of instructions relative to the memory access operations performed in connection with the workload. The performance of a memory-latency-bound workload depends directly on the memory/bus frequency, but memory latency bound workloads do not generate high throughput traffic. As a consequence, existing memory/bus frequency scaling algorithms that are based on the measured throughput of traffic between a bus master and system memory do not work well for memory-latency-bound workloads.

### SUMMARY

According to an aspect, a method for adjusting a frequency of memory of a computing device includes counting, in connection with a hardware device, a number of instructions executed and a number of requests to the memory during N milliseconds. A workload ratio is calculated that is equal to a ratio of the number of instructions executed to the number of requests to memory; and a memory-frequency vote of zero is generated if the workload ratio is greater than or equal to a ratio-threshold. If the workload ratio is less than the ratio-threshold, then the memory-frequency vote is generated by determining the memory-frequency vote based upon a frequency of the hardware device, and the frequency of the memory is managed based upon an aggregation of the memory-frequency vote and other frequency votes.

According to another aspect, a computing device includes a hardware device, a memory; and a bus coupled between the memory and the hardware device. A count monitor is configured to receive a count of a number of instructions executed and a count of a number of requests to the memory, and a workload ratio module is configured to calculate a workload ratio that is equal to a ratio of the number of instructions executed to the number of requests to the memory. A voting module determines a memory-frequency vote based upon a frequency of the hardware device, and a memory frequency control module is configured to adjust a frequency of the memory based, at least in part, on the memory-frequency vote.

According to yet another aspect, a method for adjusting a frequency of memory of a computing device includes counting, in connection with a hardware device, a number of memory stall cycles during N milliseconds and calculating a workload ratio that is equal to a ratio of the number of memory stall cycles to a total count of non-idle cycles. The method also includes generating a memory-frequency vote of zero if the workload ratio is less than or equal to a ratio-threshold, and if the workload ratio is greater than a ratio-threshold, then the memory-frequency vote is generated by determining the memory-frequency vote based upon a frequency of the hardware device. The frequency of the memory is then managed based upon an aggregation of the memory-frequency vote and other frequency votes.

### BRIEF DESCRIPTION OF THE FIGURES

FIG. 1 is a block diagram that generally depicts functional components of an exemplary embodiment;

FIG. 2 is a block diagram depicting an embodiment of the memory-latency-bound voting module depicted in FIG. 1;

FIG. 3 is a flow chart depicting aspects of a method that may be carried out in connection with embodiments disclosed herein;

FIG. 4 is a block diagram of an exemplary processor-based system that may be utilized in connection with many embodiments;

FIG. 5 is a graph depicting aspects of a memory-latency-bound workload;

FIG. 6 is another graph depicting traffic throughput associated with a memory-latency-bound workload;

FIG. 7 is yet another graph depicting traffic throughput associated with embodiments herein that provide improved performance;

FIG. 8 is a flow chart depicting aspects of another method that may be carried out in connection with embodiments disclosed herein

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Disclosed herein are proposed solutions for dynamically detecting memory-latency-bound workloads and then scaling the memory/bus frequency to operating points that are at a good balance between performance and power. An example of a memory-latency-bound workload is a workload that includes traversing all the nodes in a linked list and incrementing a field in each node. In this example workload, the read operation to fetch the address of a node has to finish before the CPU can increment a field on that node. Due to this tight data dependency, the CPU cannot do any instruction reordering, which forces the majority of the work done by the CPU to be serialized. The longer it takes to read the address of a node, the longer it will take for the CPU to traverse the same number of nodes in a linked list. This tight data dependency is what makes the workload in this example memory-latency-bound. If the nodes in the link list have no cache locality, then every read will be a cache miss and will go to the memory (e.g., DDR memory).

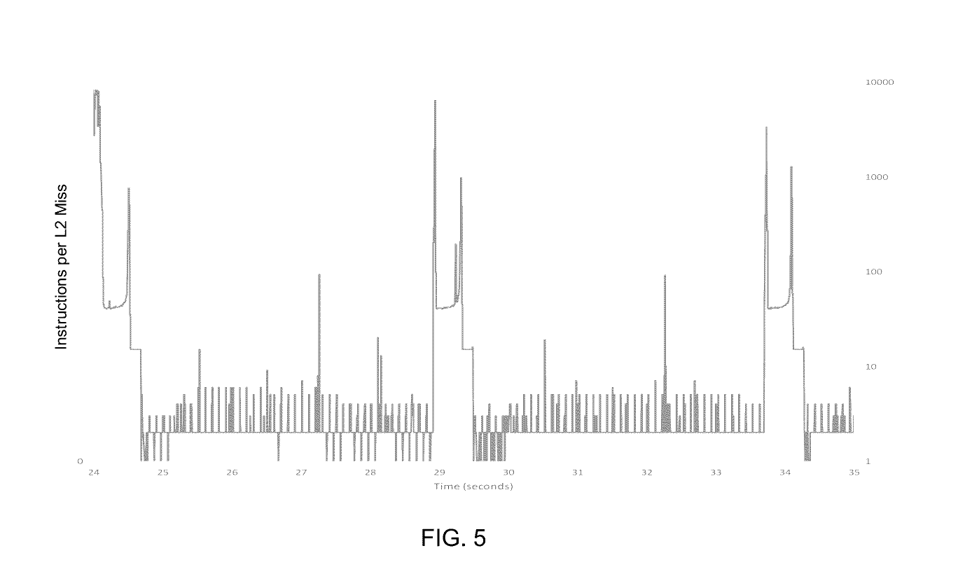

Referring to FIG. 5 for example, it is a graph depicting a workload ratio (of instructions executed to system memory accesses (L2 misses)) versus time on a system that has an L1 and L2 cache between the CPU and system memory. As shown at about 29 seconds, up to several thousand instructions are executed per system memory access (L2 miss) in substantially less than a second (about 10 milliseconds), which is indicative of a workload that is not memory-latency-bound. Right after, for about half a second, about 50 instructions are executed per system memory access, which is indicative of a workload that is heavy to moderately memory-latency-bound. But between about 30 and 33 seconds, very few instructions (generally less than 10 instructions) are executed for every system memory access (L2 miss), which indicates the workload is extremely memory-latency-bound.

In general, a workload has aspects of being memory-latency-bound when less than two thousand instructions are executed per memory access. When 0 to 20 instructions are executed per memory access, the workload is considered to be extremely memory-latency-bound, and when between 20 and 200 instructions are executed per memory access, the work load is considered to be heavy to moderately memory-latency-bound. According to an aspect, a ratio-threshold (for determining when to generate a memory frequency vote) is a configurable value, which may be set to a default value of 200.

Even in the case of a cache (e.g., an L1 or L2 cache) miss, the traffic throughput to memory (e.g., DDR memory) is very low because the CPU won't have multiple read/writes in progress at the same time. This is what makes the existing traffic-throughput-based algorithms not work well for memory-latency-bound workloads. Throughout this disclosure, embodiments are discussed in connection with a CPU, but this is generally for ease of description, and the methodologies disclosed herein are generally applicable in connection with other types of hardware devices. For example, the proposed solutions may be extended from CPUs to other masters such as graphics processing units (GPUs), busses such as cache coherent interconnects (CCIs) and slaves such as an L3 cache. Similarly, DDR memory is utilized as a common example of a type of memory, but it should be recognized that other types of memory devices may also be utilized.

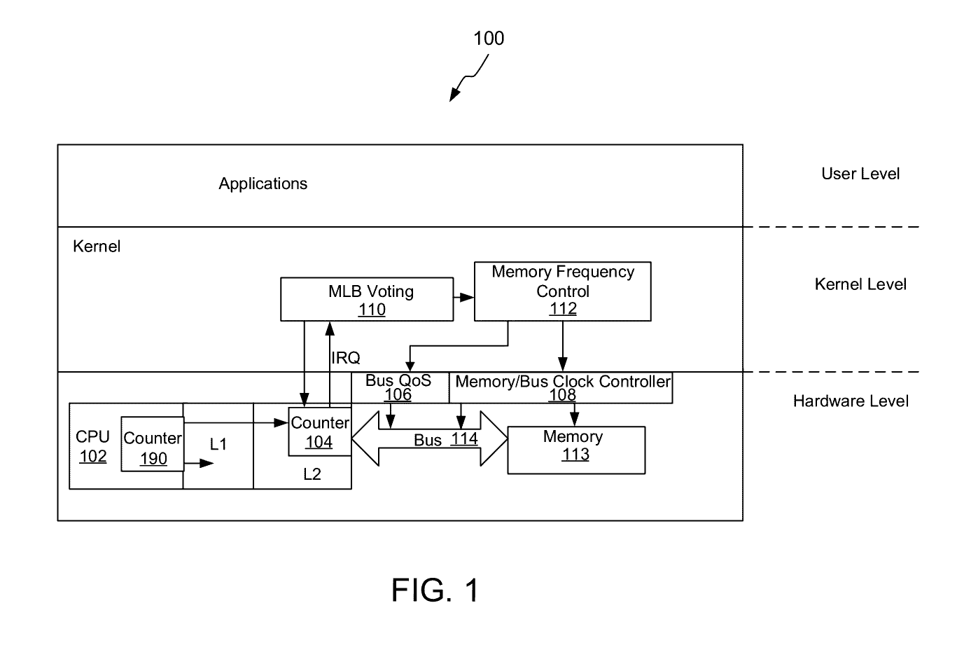

Referring to FIG. 1, shown is a computing device 100 depicted in terms of abstraction layers from hardware to a user level. The computing device 100 may be implemented as any of a variety of different types of devices including smart phones, tablets, netbooks, set top boxes, entertainment units, navigation devices, and personal digital assistants, etc. As depicted, applications at the user level operate above the kernel level, which is disposed between the user level and the hardware level. In general, the applications at the user level enable a user of the computing device 100 to interact with the computing device 100 in a user-friendly manner, and the kernel level provides a platform for the applications to interact with the hardware level.

The depicted computing device 100 is an exemplary embodiment in which memory-latency-bound workloads associated with a CPU 102 (also referred to generally as a hardware device 102) are monitored by a counter 104 in connection with a memory-latency-bound (MLB) voting module 110. As depicted in the hardware level, the CPU 102 is in communication with memory 113 (e.g., DDR memory) via a first level cache memory (L1), a second level cache memory (L2), and a system bus 114. Also depicted at the hardware level are a bus quality of service (QoS) component 106, and a memory/bus clock controller 108. As depicted, the L2 memory in this embodiment includes the performance counter 104, and at the kernel level, the MLB voting module 110 is in communication with the performance counter 104 and a memory/bus frequency control component 112 that is in communication with the bus QoS component 106 and the memory/bus clock controller 108.

In this embodiment, the memory/bus frequency control component 112 operates to control the bus QoS 106 and memory/bus clock controllers 108 to effectuate the desired bus and/or memory frequencies. The performance counter 104 in the L2 cache provides an indication of the amount of data that is transferred between the L2 cache and memory 113. One of ordinary skill in the art will appreciate that most L2 cache controllers include performance counters, and the depicted performance counter 104 (also referred to herein as the counter 104) in this embodiment is specifically configured (as discussed further herein) to count the read/write events that occur when data is transferred between the L2 cache and the memory 113 to determine how much data is transferred between the L2 cache and memory 113.

According to an aspect, performance counters (or purpose built counters) such as the counter 190 in each hardware device (such as the CPU 102) are used to count the number of instructions executed and the counter 104 counts a number of memory 113 accesses (or other access requests such as L2 misses or bus 114 accesses from the CPU 102).

If the instruction to memory 113 access ratio is less than a ratio-threshold, the workload may be classified as memory-latency-bound. For the exact same workload, the instruction to memory 113 access ratio can be different for different CPU architectures. Therefore, the ratio-threshold for classifying a workload as a memory-latency-bound workload will depend on the architecture of the CPU. In a multicore or multicluster system with different CPU architectures, a different ratio-threshold could be used for each CPU architecture type. In an embodiment, a memory-latency-bound module such as the MLB voting module 110 may perform the algorithms/methods performed herein. As one of ordinary skill in the art in view of this disclosure will appreciate, the MLB voting module 110 may be realized by hardware or a combination of hardware and software.

When a memory-latency-bound workload is executing, a faster frequency for the memory 113 will reduce the time taken to finish the work and improve the system performance depending on the extent the workload is memory-latency-bound. But the system performance to power ratio does not increase linearly with an increase in the frequency of the memory 113. For example, running the memory 113 at 1.5 GHz when running the CPU at 300 MHz might not be the most efficient choice of frequencies. It might be more optimal to run the CPU at 600 MHz and the memory at 1 GHz, or instead, it may be more optimal to run the CPU at 800 MHz and the memory at 800 MHz.

But for a given CPU frequency, a workload that only runs for 1 millisecond does not need to be handled at as high a DDR frequency as one that runs for 20 ms. So, in many embodiments the average CPU frequency over N milliseconds (considering idle time as 0 Hz) is used when deciding a DDR frequency. Also, one CPU at 1 GHz might not consume the same power as another CPU at 1 GHz. So, in many embodiments the computing performance per Watt for the CPU (e.g., measured in millions of instructions per milliwatt (MIPS)/mW) should also be taken into consideration when picking the DDR frequency for a memory-latency-bound workload.

So, in many embodiments, to arrive at a good performance/power ratio, the average CPU frequency is computed and mapped to a corresponding DDR frequency depending on the CPU's power metric. For any CPU that is not running a memory-latency-bound workload, a DDR frequency vote of 0 may be selected. But if the CPU is running memory-latency-bound work, an average CPU frequency to DDR mapping may be used for that CPU to determine the non-zero DDR frequency vote for that CPU.

Because multiple CPUs may each have a different DDR frequency vote, the votes from the CPUs are aggregated by picking the maximum of the DDR frequency votes across all the CPUs. The algorithm/idea then makes a final DDR frequency vote.

In many embodiments, the resultant vote does not decide the final DDR frequency, but instead the resultant vote is one vote among other DDR frequency votes which are then combined with votes from other masters (such as votes based on a measured-throughput-based scaling algorithm) to pick a final DDR frequency.

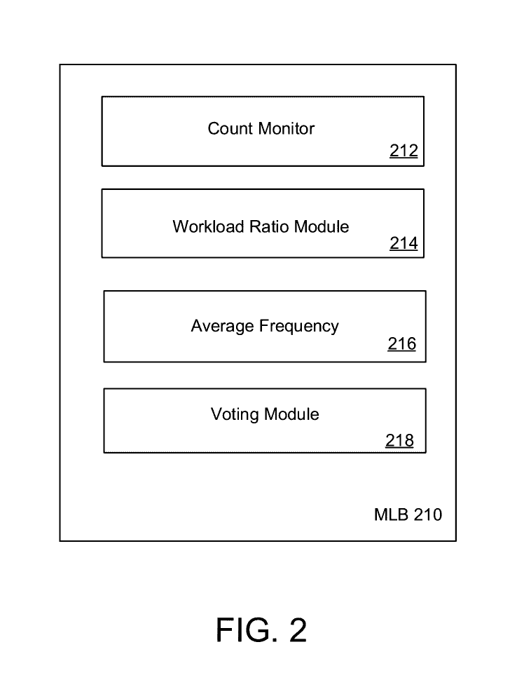

Referring next to FIG. 2, shown is a block diagram depicting an embodiment of the MLB voting module 110 described with reference to FIG. 1. As shown, the MLB 210 in this embodiment includes a count monitor 212, a workload ratio module 214, an average frequency module 216, and a voting module 218. It should be recognized that the depiction of components in FIG. 2 is a logical depiction and is not intended to depict discrete software or hardware components, and in addition, the depicted components in some instances may be separated or combined. For example, the depiction of distributed components is exemplary only, and in some implementations the components may be combined into a unitary module. In addition, it should be recognized that each of the depicted components may represent two or more components distributed about the computing device 100.

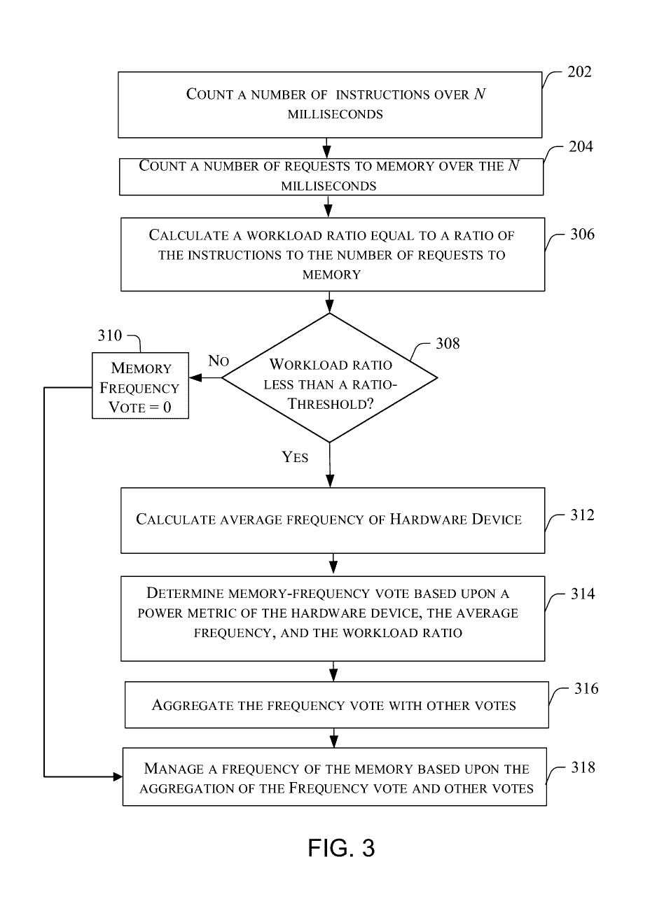

While referring to FIG. 2, simultaneous reference is made to FIG. 3, which is a flowchart that depicts a method that may be carried out in connection with embodiments described herein. For simplicity, FIG. 3 depicts a single iteration of a loop that may repeat every N milliseconds so that a new frequency vote is generated every N milliseconds.

The count monitor 212 is configured to monitor, in connection with a hardware device (e.g., the CPU 102), both the number of instructions executed (Block 302) and a number of requests to memory (Block 304). In some embodiments, the counts are obtained over a time period of N milliseconds. As shown in FIG. 1, the instructions executed may be counted using the counter 190 and the number of requests to memory may be counted by the counter 104. The workload ratio module 214 then calculates a workload ratio equal to a ratio of the instructions executed to the number of requests to memory (Block 306). If the workload ratio is not less than a ratio-threshold (Block 308), then a memory frequency vote equal to zero is generated (Block 310).

If the workload ratio is less than a ratio-threshold (Block 308), an average frequency of the hardware device is calculated (Block 312), and a memory-frequency vote may be determined based upon a type of the hardware device that is being monitored, the average frequency of the hardware device, and the workload ratio (Block 314). The memory-frequency vote is then aggregated with other votes (Block 316), and a frequency of the memory 113 is managed, based upon the memory-frequency vote and other frequency votes.

The following is a pseudo-code representation of a method that is consistent with the method depicted in FIG. 3:

Every N milliseconds
DDR =0
For each CPU
   use performance counters to count the number of instructions executed and the number of DDR access in the past N milliseconds
   workload_ratio=instruction count/DDR access count
   If workload ratio <ratio-threshold
      Use CPU cycle counter to count the number of non-idle CPU cycles in the past N milliseconds
      cpu_avg_freq (in KHz)=non-idle CPU cycles/N
      CPU_DDR_vote=CPU_to_DDR_freq(CPU, cpu_avg_freq, workload_ratio)
      DDR_vote=max(DDR_vote, CPU_DDR_vote)
Send the DDR_vote to the DDR frequency managing module.

It should be noted that software tracking of CPU frequency and idle time can also be used to get an approximate cpu_avg_freq. It should also be recognized that the CPU_to_DDR_freq( ) may either be a mapping table using all the inputs or a simple mathematical expression that uses the inputs and scaling factors with floor/ceiling thresholds for CPU frequency, DDR frequency, and workload ratio.

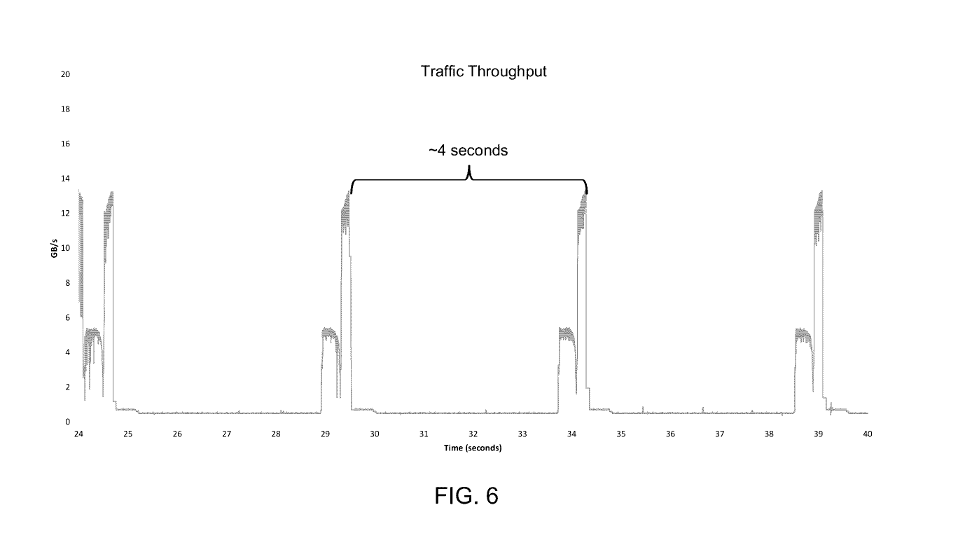

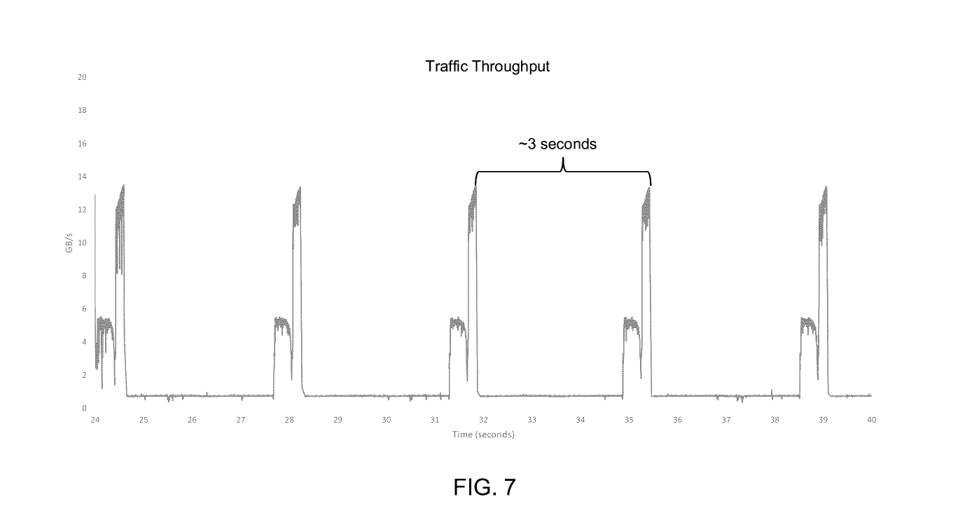

Referring to FIGS. 6 and 7, shown are workload graphs depicting traffic throughput in connection with execution of a workload without the methods described herein and with the methods described herein, respectively. As shown in FIG. 7, using a workload ratio of 10 and a 1-to-1 CPU to DDR frequency mapping, the duration of memory latency bound workload that hits DDR memory a majority of the time has decreased from approximately 4 seconds to 3 seconds. Moreover, 5 iterations have run (as depicted in FIG. 7) instead of 4 (as depicted in FIG. 6) for the same duration (16 seconds), which is approximately a 25% improvement in performance.

### Extending for Other Memories, Busses and Masters

### Memories

Although references in the description above are generally made to memory (e.g., DDR memory), the same methodologies apply to other types of memory such as L3 cache (slave to CPUs), system cache, and IMEM that run asynchronous to the bus masters. For example, the same method described with reference to FIG. 3 may be used to determine the frequency of a L3 cache that runs asynchronous to CPUs and DDR memory.

### Busses

Similarly, many of the ideas disclosed herein may be used to decide the frequency of busses that connect a bus master to a memory. For example, the method described with reference to FIG. 3 may be used to determine a frequency of a cache coherent interconnect that connects one or more CPU/clusters to the DDR.

### Masters

In addition, many of the systems and methods disclosed herein may be used in connection with other bus masters like GPU, L3 (bus master to DDR), and DSPs by using a different unit for counting instructions executed and picking a corresponding ratio-threshold. In other words, multiple activities/events may be equated to a unit to be counted. In connection with a GPU, for example, shading a pixel may be equated to one instruction, and in connection with an L3 cache memory, a number of N cache hits may be equated to one instruction to decide a memory frequency vote.

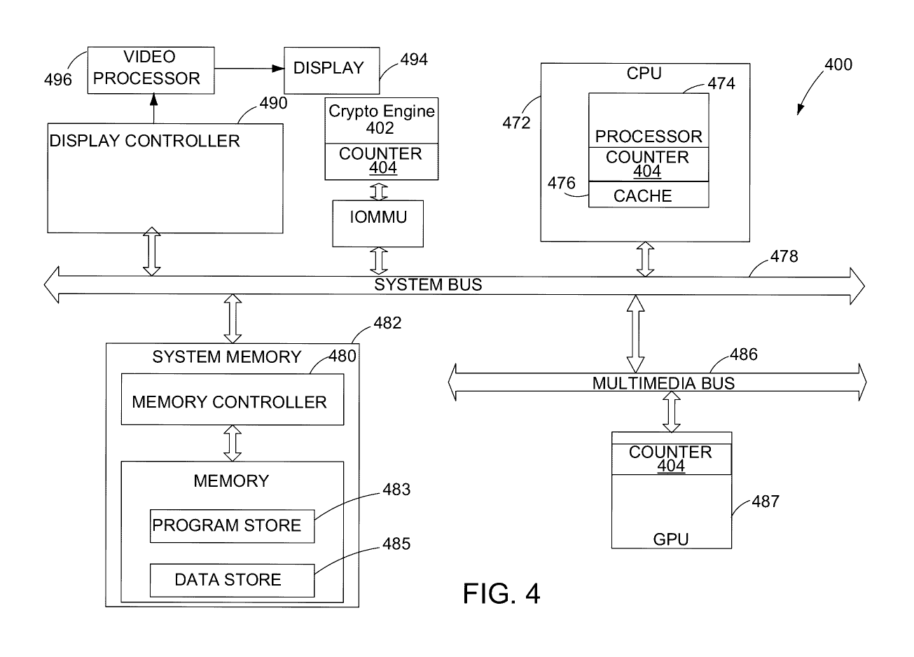

Referring to FIG. 4, shown is an example of a processor-based system 400 that depicts other memories, busses and masters that the methods described herein may apply to. As shown, FIG. 4 includes a distribution of counters 404 and exemplary hardware devices such as a graphics processing unit (“GPU”) 487, a memory controller 480, a crypto engine 402 (also generally referred to as a hardware device 402), and one or more central processing units (CPUs) 472, each including one or more processors 474. The CPU(s) 472 may have cache memory 476 coupled to the processor(s) 474 for rapid access to temporarily stored data. The CPU(s) 472 is coupled to a system bus 478 and can inter-couple master devices and slave devices included in the processor-based system 470. As is well known, the CPU(s) 472 communicates with these other devices by exchanging address, control, and data information over the system bus 478. For example, the CPU(s) 472 can communicate bus transaction requests to the memory controller 480 as an example of a slave device. In addition to the system bus 478, the processor-based system 400 includes a multimedia bus 486 that is coupled to the GPU 487 hardware device and the system bus 478. Although not illustrated in FIG. 3, multiple system buses 478 could also be provided, wherein each system bus 478 constitutes a different fabric.

As illustrated in FIG. 4, the system 400 may also include a system memory 482 (which can include program store 483 and/or data store 485). Although not depicted, the system 400 may include one or more input devices, one or more output devices, one or more network interface devices, and one or more display controllers. The input device(s) can include any type of input device, including but not limited to input keys, switches, voice processors, etc. The output device(s) can include any type of output device, including but not limited to audio, video, other visual indicators, etc. The network interface device(s) can be any devices configured to allow exchange of data to and from a network. The network can be any type of network, including but not limited to a wired or wireless network, private or public network, a local area network (LAN), a wide local area network (WLAN), and the Internet. The network interface device(s) can be configured to support any type of communication protocol desired.

The CPU 472 may also be configured to access the display controller(s) 490 over the system bus 478 to control information sent to one or more displays 494. The display controller(s) 490 sends information to the display(s) 494 to be displayed via one or more video processors 496, which process the information to be displayed into a format suitable for the display(s) 494. The display(s) 494 can include any type of display, including but not limited to a cathode ray tube (CRT), a liquid crystal display (LCD), a plasma display, etc.

### Extending for Memory-Stall Cycle Counters

Some CPUs and other devices have performance counters that can count the number of clock cycles where the entire device was completely blocked (not executing any other pipelines in parallel) while waiting for a memory read/write to complete. As used herein, a memory-stall cycle count refers to the number of clock cycles where the device is completely blocked while waiting for a memory read/write to complete. In addition, it is sometimes difficult to count a number of instructions executed (Block 302) simply because, for some devices (such as a GPU 487 or crypto engine 402), it is difficult to define what an executed instruction is.

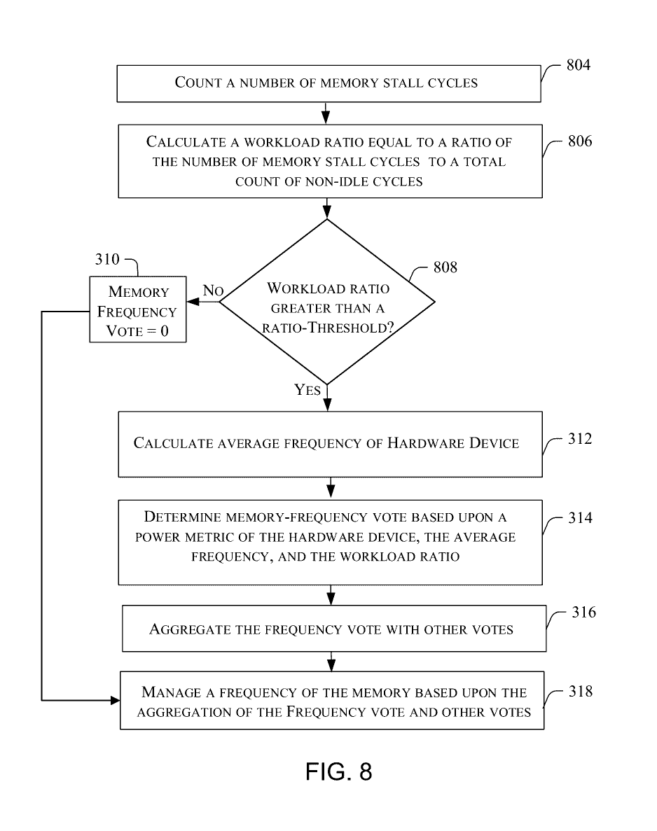

In such cases, the memory stall cycle count can be used as a method to detect a memory latency bound workload. Referring to FIG. 8 for example, shown is another method that may be executed in connection with embodiments disclosed herein. In this method, a number of memory stall cycles are counted (Block 804), and a workload ratio equal to a ratio of the memory stall cycle count to a total count of non-idle cycles is calculated (Block 806). If this workload ratio is greater than a ratio-threshold (also referred to as a wasted-percentage threshold) (Block 808), the workload is considered to be a memory latency bound workload, and blocks 312-318 are carried out as described with reference to FIG. 3. If the workload ratio is not greater than a ratio-threshold (Block 808), then blocks 310 and 318 are carried out as described with reference to FIG. 3.

If these counters have a threshold or overflow IRQ capability, it can be used to get an early notification (shorter than N milliseconds) when a memory latency bound workload starts. The threshold for the IRQ should be computed as:

threshold=current CPU frequency*(N/1000)*(wasted-percentage threshold/100)

This method is especially useful for masters where an “instruction” can't be clearly defined.

What is claimed is:

1. A method for adjusting a frequency of memory of a computing device, the method comprising:
counting, in connection with a hardware device, a number of instructions executed and a number of requests to the memory during N milliseconds;
calculating a workload ratio of the number of instructions executed to the number of requests to memory;
generating a memory-frequency vote of zero if the workload ratio is greater than or equal to a ratio-threshold; and
if the workload ratio is less than the ratio-threshold, then generating the memory-frequency vote includes:
determining the memory-frequency vote based upon a frequency of the hardware device; and
managing the frequency of the memory based upon an aggregation of the memory-frequency vote and other frequency votes.

2. The method of claim 1, wherein the ratio-threshold is configurable based upon an architecture of the hardware device.

3. The method of claim 1, wherein determining the memory-frequency vote includes:
selecting a mapping table from among a plurality of mapping tables based upon a power metric, wherein each of the mapping tables corresponds to one of a plurality of power metrics; and
selecting the memory-frequency vote from the selected mapping table using the frequency.

4. The method of claim 1, wherein determining the memory-frequency vote includes:
calculating the memory-frequency vote with an expression that utilizes a power metric, the frequency, and the workload ratio.

5. The method of claim 1, including:
computing an average frequency of the hardware device over the N milliseconds;
wherein the frequency used to determine the memory-frequency vote is the average frequency.

6. A computing device comprising:
a hardware device;
a memory;
a bus coupled between the memory and the hardware device;
a count monitor to receive a count of a number of instructions executed and a count of a number of requests to the memory;
a workload ratio module configured to calculate a workload ratio of the number of instructions executed to the number of requests to the memory;
a voting module configured to determine a memory-frequency vote based upon a frequency of the hardware device; and
a memory frequency control module configured to adjust a frequency of the memory based, at least in part, on the memory-frequency vote.

7. The computing device of claim 6, wherein the hardware device is a hardware device selected from the group consisting of: a system cache, CPU, a GPU, an L3 cache, a cache coherent interconnect, and a DSP, and wherein the memory is selected from the group consisting of DDR memory, IMEM, system cache, and L3 cache.

8. The computing device of claim 6, including a plurality of mapping tables, each of the mapping tables corresponds to one of a plurality of power metrics, and each of the mapping tables maps frequency values to memory-frequency votes.

9. The computing device of claim 6, wherein the voting module is configured to calculate the memory-frequency vote with an expression that utilizes a power metric, frequency, and workload ratio of the hardware device.

10. The computing device of claim 6, including:
an average frequency module configured to calculate an average frequency of the hardware device over N milliseconds;
wherein the frequency used to determine the memory-frequency vote is the average frequency.

11. A non-transitory, tangible computer readable storage medium, encoded with processor readable instructions to perform a method for adjusting a frequency of memory of a computing device, the method comprising:
counting, in connection with a hardware device, a number of instructions executed and a number of requests to the memory during N milliseconds;
calculating a workload ratio of the number of instructions executed to the number of requests to memory;
generating a memory-frequency vote of zero if the workload ratio is greater than or equal to a ratio-threshold; and
if the workload ratio is less than the ratio-threshold, then generating the memory-frequency vote includes:
determining the memory-frequency vote based upon a frequency of the hardware device; and
managing the frequency of the memory based upon an aggregation of the memory-frequency vote and other frequency votes.

12. The non-transitory, tangible computer readable storage medium of claim 11, wherein the ratio-threshold is configurable based upon an architecture of the hardware device.

13. The non-transitory, tangible computer readable storage medium of claim 11, wherein determining the memory-frequency vote includes:
selecting a mapping table from among a plurality of mapping tables based upon a power metric, wherein each of the mapping tables corresponds to one of a plurality of power metrics; and
selecting the memory-frequency vote from the selected mapping table using the frequency.

14. The non-transitory, tangible computer readable storage medium of claim 11, wherein determining the memory-frequency vote includes:
calculating the memory-frequency vote with an expression that utilizes a power metric, the frequency, and the workload ratio.

15. The non-transitory, tangible computer readable storage medium of claim 11, the method including:
computing an average frequency of the hardware device over the N milliseconds;
wherein the frequency used to determine the memory-frequency vote is the average frequency.

16. A method for adjusting a frequency of memory of a computing device, the method comprising:
counting, in connection with a hardware device, a number of memory stall cycles during N milliseconds;
calculating a workload ratio that is equal to a ratio of the number of memory stall cycles to a total count of non-idle cycles;
generating a memory-frequency vote of zero if the workload ratio is less than or equal to a ratio-threshold;
if the workload ratio is greater than a ratio-threshold, then generating the memory-frequency vote includes:
determining the memory-frequency vote based upon a frequency of the hardware device; and
managing the frequency of the memory based upon an aggregation of the memory-frequency vote and other frequency votes.

17. The method of claim 16, wherein the frequency is an average frequency of the hardware device that is computed in response to an interrupt from a counter.

18. The method of claim 17, wherein a threshold for the interrupt is equal to f*(N/1000)*(wasted-percentage threshold/100), wherein f is a current frequency of the hardware device.

19. The method of claim 16, including:
computing an average frequency of the hardware device over the N milliseconds;
wherein the frequency used to determine the memory-frequency vote is the average frequency.
